(19) United States
(12) Patent Application Publication
(10) Pub. No.: US 2005/0162683 A1
(43) Pub. Date: Jul. 28, 2005

(54) Image processing apparatus

(75) Inventor: Takuya Kotsuji, Tagata-gun (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/763,270

(22) Filed: Jan. 26, 2004

(51) Int. Cl. G06F 15/00; G06K 9/46

(52) U.S. Cl. 358/1.15; 382/232; 358/1.17

(57) ABSTRACT

There is disclosed an image processing apparatus including a compression processing section which compresses and encodes image data, a storage section which stores the encoded data a code separation section which separates and stores the data encoded by the compression processing section in separate regions of the storage section in accordance with a separation scheme set, a key information preparation section which generates, as key information, information indicating a region in which each of the separated coded data is stored in the storage section and information indicating the separation scheme, a code synthesis section which synthesizes the separated encoded data, in accordance with the key information, and an extension processing section which extends the synthesized encoded data.

### BACKGROUND OF THE INVENTION

1. Field of the Invention

The present invention relates to an image processing apparatus which performs compression processing and extension processing of image data.

2. Description of the Related Art

In image processing apparatuses such as a copying machine, processing has heretofore been performed in copying a plurality of pages as follows. After compressing image data read from a scanner to form compressed data, the data is once stored in a hard disk in a hard disk drive (HDD). Moreover, the data is subjected to processing such as electronic sorting. Subsequently, after the compressed data is read from the hard disk and subjected to the extension processing, the data is transferred to a printer section. Moreover, printing is performed by a printer section based on the transferred data.

When the image processing is performed, there is a possibility that the compressed data stored in the hard disk of HDD is reused in reprinting or the like. Therefore, the data is not deleted soon, and held in the HDD even after printed. Since a draft having high secrecy is also copied in the copying machine, the compressed data of the image read from the draft is held in the hard disk in this case. When the compressed data is held in the hard disk, a third party accesses the HDD to easily extend the compressed data, and an image having high secrecy can be restored.

Therefore, there has been a need for an image processing apparatus which performs image data in such a manner that the image data is not restored by the third party.

### BRIEF SUMMARY OF THE INVENTION

According to an aspect of the present invention, an image processing apparatus comprises: a compression processing section which compresses and encodes image data; a storage section which stores the encoded data; a code separation section which separates and stores the data encoded by the compression processing section in separate regions of the storage section in accordance with a separation scheme set; a key information preparation section which generates, as key information, information indicating a region in which each of the separated coded data is stored in the storage section and information indicating the separation scheme; a code synthesis section which synthesizes the separated encoded data stored in the storage section, in accordance with the key information; and an extension processing section which extends the encoded data synthesized by the code synthesis section.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a diagram showing a constitution of an image processing apparatus in a first embodiment of the present invention;

FIG. 2 is a diagram showing a constitution in one block of encoded data;

FIG. 3 is a diagram showing a block constitution of the encoded data for one page;

FIG. 4A is a former half part of a flowchart showing processing of the image data;

FIG. 4B is a latter half part of the flowchart showing the processing of the image data;

FIG. 5 is a diagram schematically showing the separated encoded data stored in a hard disk;

FIG. 6A is a former half part of a flowchart showing the processing of the image data in a second embodiment of the present invention;

FIG. 6B is a latter half part of the flowchart showing the processing of the image data;

FIG. 7 is a diagram schematically showing the separated encoded data stored in the hard disk;

FIG. 8A is a former half part of the flowchart showing the processing of the image data in a third embodiment of the present invention;

FIG. 8B is a latter half part of the flowchart showing the processing of the image data; and

FIG. 9 is a diagram schematically showing the separated encoded data stored in the hard disk.

### DETAILED DESCRIPTION OF THE INVENTION

Embodiments of the present invention will be described hereinafter with reference to the drawings.

### FIRST EMBODIMENT

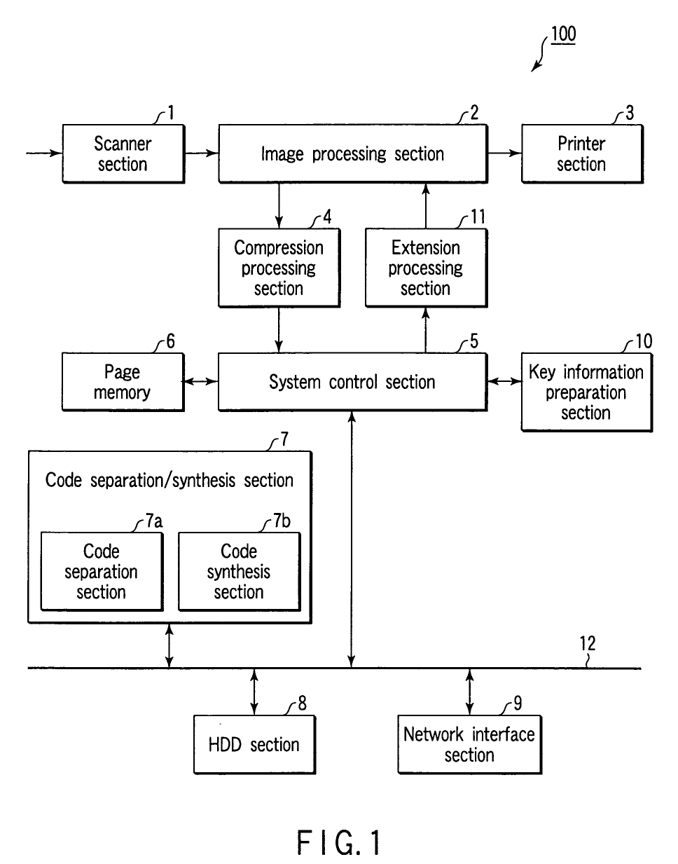

FIG. 1 is a diagram showing a constitution of an image processing apparatus 100. The image processing apparatus 100 includes a scanner section 1, image processing section 2, printer section 3, compression processing section 4, system control section 5, page memory 6, code separation/synthesis section 7, hard disk drive (HDD) section 8, network interface section 9, key information preparation section 10, extension processing section 11, bus line 12 and the like.

The scanner section 1 reads an image from a draft laid on a draft table (not shown) or a plurality of sheets of draft sent continuously from an auto document feeder (ADF) to generate image data. The scanner section 1 includes, for example, line sensors of three colors including red (R), green (G), and blue (B), a fluorescent lamp, and an image processing section (these are not shown). Moreover, the draft sent from the ADF is irradiated with light from the fluorescent lamp, and a reflected light is received by the line sensors. Moreover, after amplifying an analog signal indicating a quantity of received light, the signal is converted to digital data, and subjected to various corrections such as a shading correction and nonlinear correction to output the image data of three colors RGB. The line sensor of each color reads the draft image for each predetermined block, and outputs the image data for each page as the block of each of the colors RGB. It is to be noted that a constitution and operation for reading the image to generate the image data by the scanner section 1 are similar to conventional constitution and operation, and therefore detailed description thereof is omitted.

The image data output in this manner is input into the image processing section 2. The image processing section 2 subjects the image data to various types of image processing such as a concentration conversion process and an inking process. In the embodiment, the input image data of each of the colors RGB is not subjected to any processing once and output to the compression processing section 4. The image data input into the image processing section 2 from the extension processing section 11 is subjected to the image processing such as the concentration conversion process and inking process by the image processing section 2 to output the data to the printer section 3.

When the image data output from the image processing section 2 is input, the printer section 3 performs the printing based on the image data. Since the constitution and operation for the printing based on the image data by the printer section 3 are similar to the conventional ones, the description thereof is omitted.

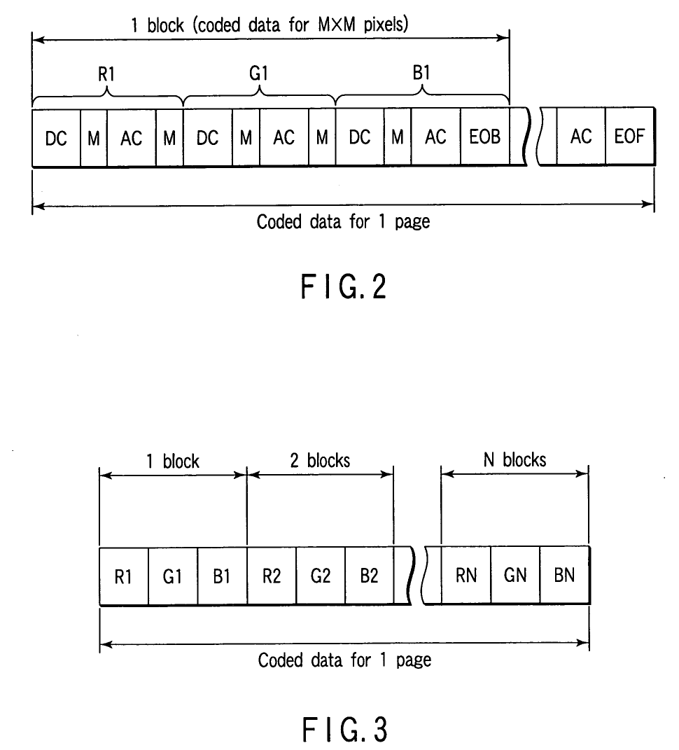

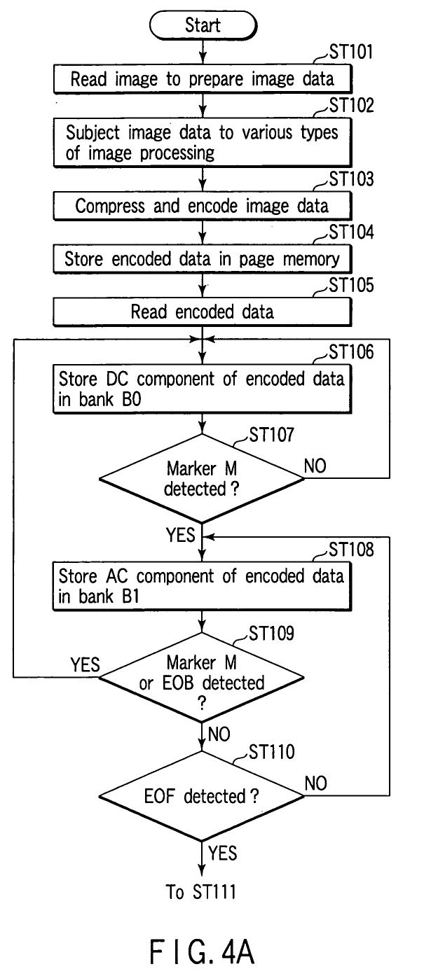

The compression processing section 4 compresses and encodes the image data of each of the colors RGB input from the image processing section 2. FIG. 2 is a diagram showing the constitution in one block of the compressed and encoded data, and FIG. 3 is a diagram showing the block constitution of the encoded data for one page. As shown in FIG. 2, the data is separated into a direct-current component (DC) and an alternating-current component (AC) for each data of each of the colors RGB of each block. A marker M is added in order to indicate the end of the data of each component. Furthermore, an end of block (EOB) is added in order to indicate the end of each block, and an end of file (EOF) is added in order to indicate the end of the data of one page. It is to be noted that the marker M is not added to the data just before EOB, EOF. As shown in FIG. 3, one page corresponds to one file, and one file comprises a group of a plurality of blocks including the data of the respective colors RGB.

The system control section 5 comprises, for example, CPU, ROM in which control program and various types of data are stored, RAM in which various areas such as a work area are formed and the like. The system control section 5 executes the control program to generally control the image processing section 2, compression processing section 4, page memory 6, code separation/synthesis section 7, HDD section 8, network interface section 9, key information preparation section 10, extension processing section 11 and the like. The system control section 5 is capable of receiving/transferring the data with respect to the compression processing section 4, page memory 6, key information preparation section 10, and extension processing section 11. Furthermore, the system control section 5 is capable of receiving/transferring the data with respect to the code separation/synthesis section 7, HDD section 8, and network interface section 9 via the bus line 12.

The page memory 6 temporarily holds various types of data such as the encoded data output from the compression processing section 4 and the encoded data read from the HDD section 8 via the system control section 5.

The code separation/synthesis section 7 comprises a code separation section 7a and code synthesis section 7b. The code separation section 7a separates the encoded data in accordance with the determined separation scheme. In the embodiment, the separation scheme is set in which the encoded data is separated into the direct-current component (hereinafter referred to as the DC component) and the alternating-current component (hereinafter referred to as the AC component). The code synthesis section 7b performs a process of synthesizing the separated encoded data into one encoded data.

Storage regions for storing a plurality of encoded data, such as a bank B0 and bank B1, are disposed in the hard disk of the HDD section 8. The bank B0 is a region for storing the DC component of the encoded data separated by the code separation section 7a, and the bank B1 is a region for storing the AC component of the encoded data separated by the code separation section 7a. It is to be noted that when there is not any empty region in the region for storing the encoded data, the data is deleted from the encoded data old in time.

The network interface section 9 is connected to a network connected to a computer device and the like in such a manner that communication is possible. Accordingly, it is possible to receive/transfer the data with respect to the computer device connected to the network.

The key information preparation section 10 prepares information indicating the separation scheme of the encoded data separated by the code separation section 7a, and the storage region in which the separated encoded data is stored in the hard disk of the HDD section 8 as the key information. The key information stored in this manner is stored in the RAM in the system control section 5. The key information stored in the RAM is deleted together, when the encoded data stored in the HDD section 8 is deleted.

The extension processing section 11 performs the extension processing of the encoded data input via the system control section 5.

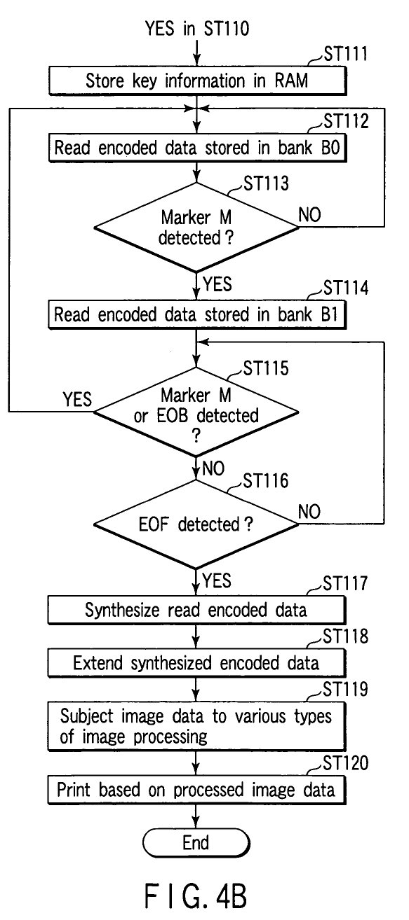

Subsequently, the processing of the image data during the copying of a plurality of sheets of draft in the image processing apparatus 100 constituted in this manner will be described. FIGS. 4A and 4B are flowcharts showing a flow of the processing of the image data. It is to be noted that FIG. 4A shows a former half part of the processing of the image data, and FIG. 4B shows a latter half part of the processing of the image data. The processing of the image data of one optional page in a plurality of pages will be described hereinafter.

When an instruction is received from a control panel or the like to start the copying (not shown), the scanner section 1 operates ADF or the like, and reads the image from the draft to generate the image data of the respective colors RGB (ST101). The image data is input into the image processing section 2, and subjected to each image processing (ST102). In the embodiment, since the image data is hot subjected to various types of image processing at this timing, the image data is output to the compression processing section 4 as it is. The input image data is compressed and encoded in the compression processing section 4 (ST103). The encoded data encoded in this manner is successively and temporarily held in the page memory 6 (ST104). The encoded data held in the page memory 6 temporarily in this manner is read out by the control of the system control section 5 (ST105).

The read encoded data is sent to the code separation section 7a, and the encoded data is separated and stored in separate regions of the hard disk of the HDD section 8 by the processing of steps ST106 to ST110 under the control of the system control section 5. First, the encoded data is stored in the bank B0 in the HDD section 8 (ST106). Subsequently, it is judged whether or not the marker M has been detected (ST107), and the process of storing the encoded data is performed until the marker M is judged to be detected. Accordingly, the DC component of the encoded data is stored in the bank B0 of the HDD section 8. When the marker M is judged to be detected in the step ST107, the subsequent encoded data is stored in the bank B1 of the HDD section 8 (ST108). Subsequently, it is judged whether or not the marker M or EOB has been detected (ST109). When the marker M or EOB is not detected, it is judged whether or not EOF has been detected (ST110). When the EOF is judged not to be detected in this judgment, the process returns to the process of the step ST108. Moreover, the process of storing the encoded data is performed until any of the marker M, EOB, and EOF is detected. Accordingly, the AC component of the encoded data is stored in the bank B1 in the HDD section 8.

On the other hand, when the marker M or EOB is detected in the step ST109, the process returns to the step ST106. When this process is repeated, the DC and AC components of the encoded data of a plurality of blocks are stored in the banks B0, B1. Moreover, when EOF is detected in the step ST110, the storage of the encoded data of the plurality of blocks constituting one page is completed, and this advances to the next process.

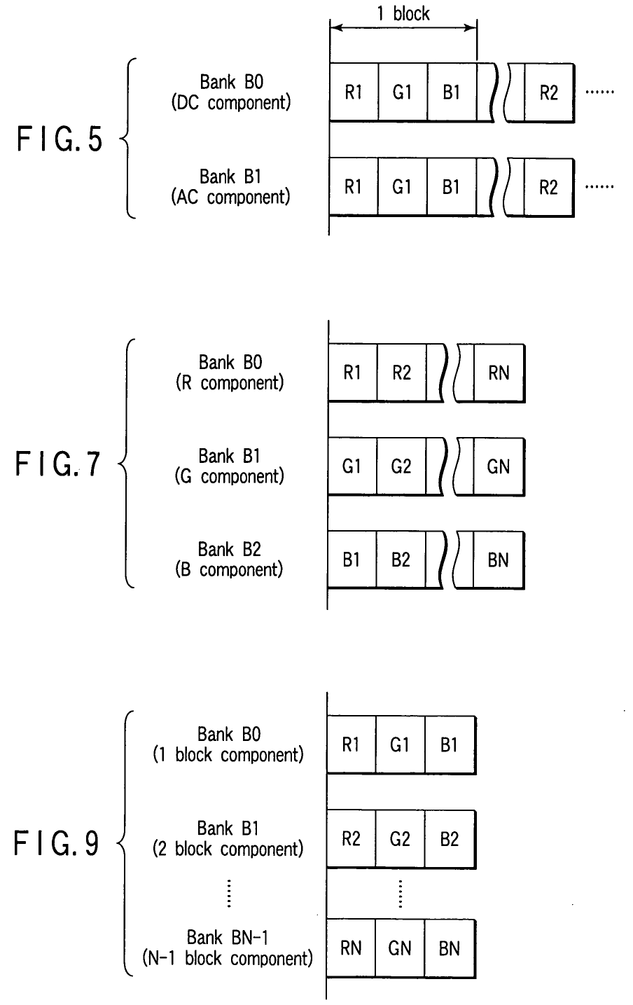

FIG. 5 is a diagram schematically showing the separated encoded data for one page stored in the hard disk in the HDD section 8. The DC component of the encoded data of each block is stored in the bank B0, and the AC component of the encoded data of each block is stored in the bank B1.

When the encoded data for one page is separated and stored in this manner, the key information is prepared (ST111). The key information preparation section 10 prepares the information indicating the separation scheme indicating that the encode has been separated by the DC and AC components and the information indicating the region of the bank B0 in which the DC component of the separated encoded data is stored and the information indicating the region of the bank B1 in which the AC component is stored as the key information. The key information is stored in the RAM of the system control section 5 as described above.

Subsequently, the process of steps ST112 to ST117 is performed to read and synthesize the encoded data separated and stored in the HDD section 8 in order to synthesize the encoded data separated in accordance with the key information stored in the RAM under the control of the system control section 5. First, the DC components of the encoded data are read from a top component from the region of the bank B0 in the HDD section 8 in accordance with the key information stored in the RAM (ST112). Moreover, it is judged whether or not the marker M has been detected (ST113), and the process of reading the DC component of the encoded data is performed until the marker M is judged to be detected. The encoded data of the DC component read in this manner is temporarily held in the page memory 6. When it is judged that the marker M has been detected in the step ST113, the AC components of the encoded data are read from the top component from the region of the bank B1 in the HDD section 8 (ST114).

Subsequently, it is judged whether or not the marker M or EOB has been detected (ST115). When the marker M or EOB is not detected, it is judged whether or not EOF has been detected (ST116). When the EOF is judged not to be detected in this judgment, the process returns to the step ST115. Moreover, the process of reading the AC component of the encoded data is performed until any of the marker M, EOB, and EOF is detected. The encoded data of the AC component read in this manner is temporarily held in the page memory 6.

On the other hand, when the marker M or EOB is detected in the step ST115, the step returns to the step ST112. By the repetition of this process, the data is read from the banks B0, B1 in the HDD section 8 in which the DC and AC components of the encoded data of the plurality of blocks are stored and temporarily held in the page memory 6. Moreover, when the EOF is detected in the step ST116, the reading of the encoded data of the plurality of blocks constituting one page is completed, and therefore the temporarily held encoded data is output to the code synthesis section 7b. The code synthesis section 7b synthesizes the encoded data of the DC and AC components for one page sent from the page memory 6 (ST117).

Moreover, the encoded data synthesized by the encode synthesis section 7b is output to the extension processing section 11. The extension processing section 11 performs an extension process of the synthesized encoded data, and outputs RGB image data to the image processing section 2 (ST118). The image processing section 2 subjects the sent image data to various types of image processing such as the concentration conversion process and inking process (ST119). The image data processed in this manner is sent to the printer section 3. The printer section 3 performs the printing based on the image data processed in this manner (ST120).

The processing of the image data performed for one page has been described, but each page is similarly processed with respect to the image data of all the pages during the copying of the plurality of pages.

Therefore, when the plurality of pages are copied by the processing of the image processing apparatus 100, the encoded data of the image data read for each page is separated into the DC and AC components, and stored in the separate region banks B0, B1 of the hard disk in the HDD section 8. In this manner, the encoded data is separated and stored in the separate regions on the hard disk in the HDD section 8. Moreover, the key information constituting a key for the synthesis is stored in the RAM in the system control section 5. Therefore, even when a third party accesses the HDD section 8 after the print-out, the image data cannot be restored. Therefore, the secrecy of the image of the draft which has been copied can be enhanced.

### SECOND EMBODIMENT

Next, a second embodiment will be described. It is to be noted that the same part as that of the above-described embodiment is denoted with the same reference numerals and the detailed description is omitted. The present embodiment is different from the first embodiment in the separation process in the code separation section 7a, the region for storing the separated encoded data in the HDD section 8, and the synthesis process of the separated encoded data. Concretely, three encoded data separated for each color data of RGB are stored in three different regions (banks B0, B1, B2) of the hard disk of the HDD section 8, and the respective encoded data are read and synthesized.

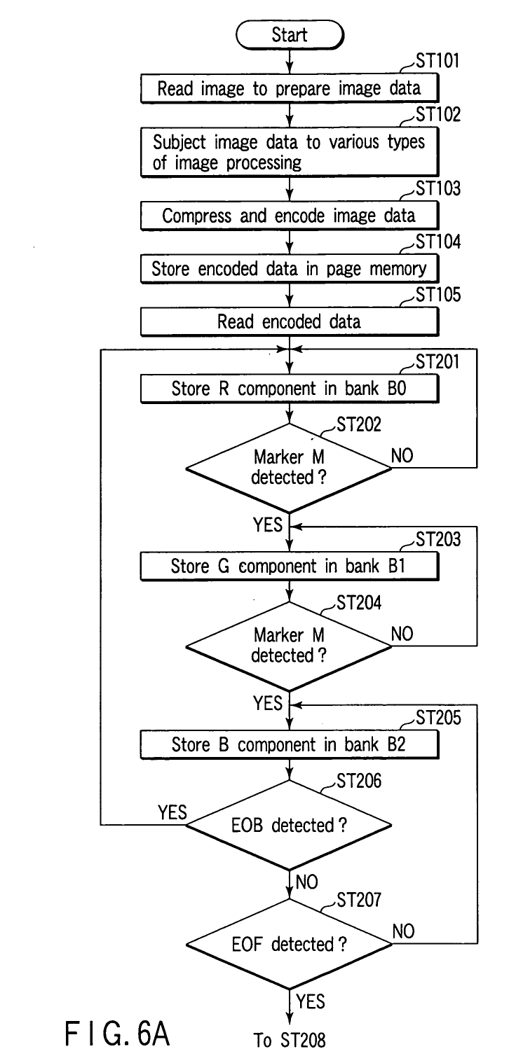

FIGS. 6A and 6B are flowcharts showing the flow of the processing of the image data in the embodiment. FIG. 6A is a former half part of the processing of the image data, and FIG. 6B is a latter half part of the processing of the image data. Mainly the process of steps ST201 to ST215 which is different from that of the above-described first embodiment will be described hereinafter.

The encoded data read in the step ST105 is sent to the code separation section 7a, and the encoded data separated into the components of the respective colors RGB is separated and stored in the banks B0, B1, B2 of the hard disk in the HDD section 8 by the process of the steps ST201 to ST207 described hereinafter under the control of the system control section 5.

First, the encoded data of R component is stored in the bank B0 in the HDD section 8 (ST201). Subsequently, it is judged whether or not the marker M (second marker M in this embodiment) indicating the end of the R component has been detected (ST202), and the process of storing the encoded data is performed until the marker M is judged to be detected. Accordingly, the R component of the encoded data is stored in the bank B0 of the HDD section 8. When it is judged in the step ST202 that the marker M has been detected, the subsequent encoded data of G component is stored in the bank B1 of the HDD section 8 (ST203). Subsequently, it is judged whether or not the marker M (second marker M in this embodiment) indicating the end of the G component has been detected (ST204), and the process of storing the encoded data is performed until it is judged that the marker M has been detected. Accordingly, the G component of the encoded data is stored in the bank B1 of the HDD section 8. When it is judged in the step ST204 that the marker M has been detected, the subsequent encoded data of B component is stored in the bank B2 of the HDD section 8 (ST205). Subsequently, it is judged whether or not the EOB has been detected (ST206). When the EOB is not detected, it is judged whether or not the EOF has been detected (ST207). When the EOF is judged not to be detected in this judgment, the process returns to the step ST205. The process of storing the encoded data is performed until either of the EOB and EOF is detected. Accordingly, the B component of the encoded data is stored in the bank B2 in the HDD section 8.

On the other hand, when the EOB is detected in the step ST206, the process returns to the step ST201. When this process is repeated, the R, G, B components of the encoded data of the blocks are stored in the banks B0, B1, B2. Moreover, when the EOF is detected in the step ST207, the storage of the encoded data of the blocks constituting one page is completed, and this advances to the next process.

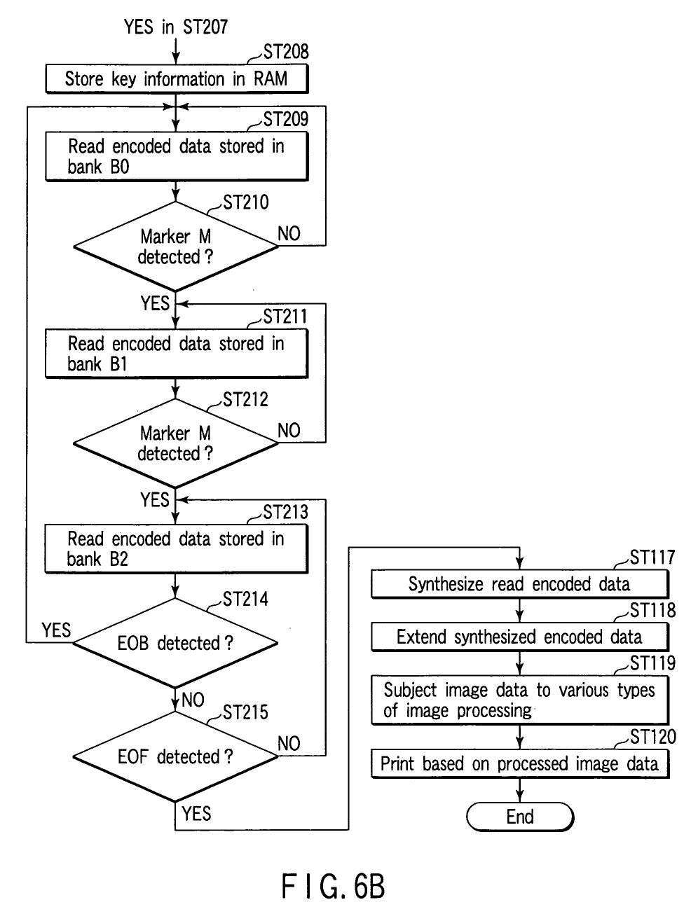

FIG. 7 is a diagram schematically showing the separated coded data for one page stored in the hard disk of the HDD section 8 as described above. The R component is stored in the bank B0, the G component is stored in the bank B1, and the B component is stored in the bank B2.

Moreover, the key information is prepared by the key information preparation section 10 substantially in the same manner as in the process of the step ST111 (step ST208).

Subsequently, a process of steps ST209 to ST215 of reading the encoded data stored in the hard disk of the HDD section 8 is performed in order to synthesize the separated encoded data in accordance with the key information stored in the RAM under the control of the system control section 5. This process will be described hereinafter.

First, the R component of the encoded data is read from the top from the region of the bank B0 in the HDD section 8 in accordance with the key information stored in the RAM (ST209). Moreover, it is judged whether or not the marker M indicating the end of the R component (third marker M in the embodiment) has been detected (ST210), and the process of reading the R component of the encoded data is performed until it is judged that the marker M has been detected. The encoded data of the R component read in this manner is temporarily held in the page memory 6. When it is judged that the marker M has been detected in the step ST210, the G component of the encoded data is read from the top from the region of the bank B1 in the HDD section 8 (ST211). Moreover, it is judged whether or not the marker M indicating the end of the G component (fourth marker M in the embodiment) has been detected (ST212), and the process of reading the G component of the encoded data is performed until it is judged that the marker M has been detected. The encoded data of the G component read in this manner is temporarily held in the page memory 6. When it is judged in the step ST212 that the marker M has been detected, the B component of the encoded data is read from the top from the region of the bank B2 in the HDD section 8 (ST213). Subsequently, it is judged that the EOB has been detected (ST214). When the EOB is not detected, it is judged whether or not the EOF has been detected (ST215). When it is judged that EOF is not detected in this judgment, the process returns to the step ST213. The process of reading the B component of the encoded data in this manner is performed until either of the EOB and EOF is detected. Accordingly, the encoded data of the read B component is temporarily held in the page memory 6.

On the other hand, when the EOB is detected in the step ST214, the process returns to step ST209. By the repetition of the process, the R, G, B components of the encoded data of the blocks are read from the banks B0, B1, B2 in the HDD section 8 in which the components are stored, and temporarily held in the page memory 6. Moreover, when the EOF is detected in the step ST215, the reading of the encoded data of the blocks constituting one page is completed, and the temporarily held encoded data is output to the code synthesis section 7b. Moreover, in the step ST117, the synthesis process of the encoded data is performed by the code synthesis section 7b.

An effect similar to that of the first embodiment can be produced even in the image processing apparatus 100 constituted in this manner.

### THIRD EMBODIMENT

Next, a third embodiment will be described. It is to be noted that the same part as that of the above-described embodiment is denoted with the same reference numerals and the detailed description is omitted. The present embodiment is different from the first embodiment in the separation process in the code separation section 7a, the region for storing the separated encoded data in the HDD section 8, and the synthesis process of the separated encoded data. Concretely, the encoded data separated in block components are stored in different regions (banks B0, B1, . . . , BN) of the hard disk of the HDD section 8, and the respective encoded data are read and synthesized.

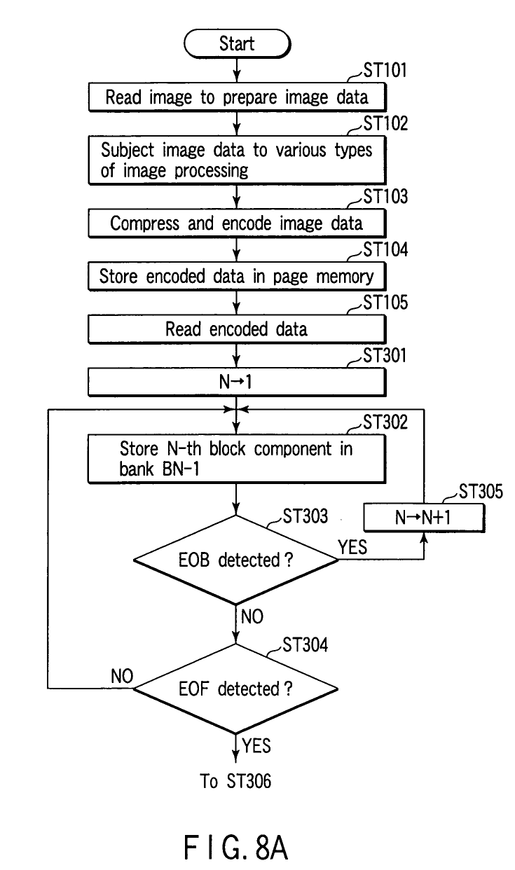

FIGS. 8A and 8B are flowcharts showing the flow of the processing of the image data in the embodiment. FIG. 8A is a former half part of the processing of the image data, and FIG. 8B is a latter half part of the processing of the image data. Mainly the process of steps ST301 to ST311 which is different from that of the above-described first embodiment will be described hereinafter.

The encoded data read in the step ST105 is sent to the code separation section 7a, and the coded data separated into the respective block components are separated and stored in the banks B0, B1, . . . , BN of the hard disk in the HDD section 8 by the process of steps ST301 to ST305 described hereinafter under the control of the system control section 5. The process will be described hereinafter.

First, a variable N is set to “1” (ST301). This variable N is used for setting a block number and bank number to be read. Moreover, an N-th block component of the encoded data (i.e., first block component) is stored in the bank B0 of the HDD section 8 (ST302). Subsequently, it is judged whether or not the EOB has been detected (ST303), and it is further judged whether or not the EOF has been detected (ST304). When the EOF is judged not to be detected in this judgment, the process returns to the step ST302. Accordingly, the first block component of the encoded data is stored in the bank B0 in the HDD section 8. When it is judged in the step ST303 that the EOB has been detected, a process of adding 1 to the variable N is performed (ST305), and the process returns to the step ST302. Accordingly, the N-th block (i.e., second block) component of the encoded data is next stored in the banks B1 of the HDD section 8 (ST302). Every time the EOB is detected, the encoded data is stored in a new bank on the hard disk. When the EOF is detected in the step ST304, the storage of the encoded data of the blocks constituting one page is completed, and this advances to the next process. In this manner, the encoded data separated into the respective block components are stored in the banks B0, B1, . . . , BN of the HDD section 8.

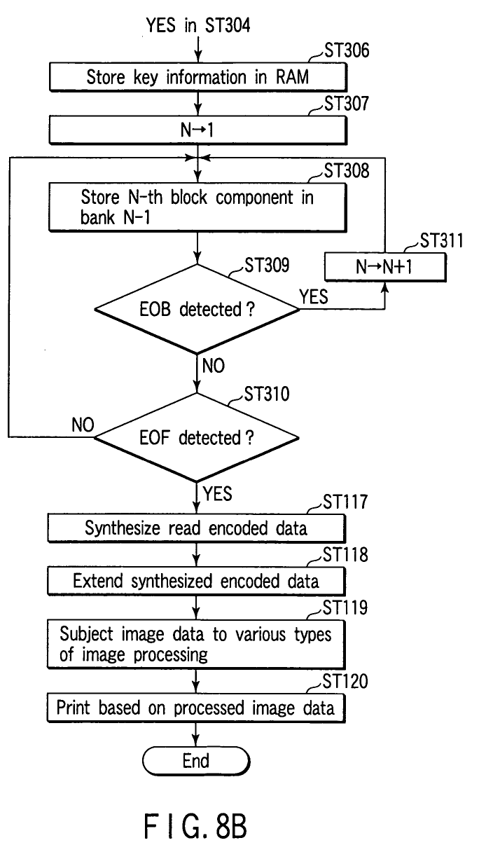

FIG. 9 is a diagram schematically showing the separated encoded data for one page stored in the hard disk of the HDD section 8. The first block component is stored in the bank B0, the second block component is stored in the bank B1, and the N-th block component is stored in the bank BN.

Moreover, the key information is prepared by the key information preparation section 10 substantially in the same manner as in the process of the above-described step ST111 (step ST306).

Subsequently, the process of steps ST307 to ST311 of reading the encoded data stored in the hard disk of the HDD section 8 is performed in order to synthesize the separated encoded data in accordance with the key information stored in the RAM under the control of the system control section 5. This process will be described hereinafter.

First, the variable N is set to “1” (ST307). Moreover, the N-th block component (i.e., first block component) of the encoded data is read from the top from a bank BN-1 (i.e., bank B0) of the HDD section 8 in accordance with the key information stored in the RAM of the system control section 5 (ST308). Subsequently, it is judged whether or not the EOB has been detected (ST309), and it is further judged whether or not the EOF has been detected (ST310). When the EOF is judged not to be detected in this judgment, the process returns to the step ST308. Accordingly, the first block component of the encoded data read from the bank B0 of the HDD section 8 is temporarily held in the page memory 6. When it is judged in the step ST309 that the EOB has been detected, the process of adding 1 to the variable N is performed (ST311), and the process returns to the step ST308. Accordingly, the second block component of the encoded data is next read from the bank B1 of the HDD section 8 and temporarily held in the page memory 6 (ST308). Every time the EOB is detected, the encoded data is read from the new bank on the hard disk and held in the page memory 6. That is, the first, second, . . . , N-th block components of the encoded data are read from the blocks B0, B1, . . . , BN of the HDD section 8, and are temporarily held in the page memory 6. Moreover, when the EOF is detected in the step ST310, the storage of the encoded data of the blocks constituting one page is completed, and the temporarily held encoded data is output to the code synthesis section 7b. Moreover, in the step ST117, the synthesis process of the encoded data is performed by the code synthesis section 7b.

An effect similar to that of the first embodiment can be produced even in the image processing apparatus 100 constituted in this manner.

In the above-described embodiments, the constitution in which the respective separated encoded data are stored in the different regions in the HDD section 8 has been described. Instead of this constitution, a part or the whole of the separated encoded data may also be stored in the HDD section in the computer device communicatably connected via the network interface. At this time, the information prepared by the key information preparation section 10 is prepared to include not only the information indicating the region of the HDD section 8 in which the separated encoded data is stored but also information indicating an address of the computer device and region stored in the HDD section of the computer device. When the separated encoded data are stored in physically different HDD section regions via the network in this manner, the secrecy of the image read from the draft can be enhanced.

Moreover, in the step ST102, a case where the image processing in the image processing section 2 is passed to send the image data of the respective colors RGB to the compression processing section 4 has been described. Instead of this process, the image processing section 2 performs, for example, the concentration conversion process, inking process and the like to convert the data to CMYK data of cyan (C), magenta (M), yellow (Y), black (K). Thereafter, the converted data may also be sent to the compression processing section 4. In this case, as described above, in addition to the separation scheme for the separations into the DC and AC components and into the respective blocks, there is a separation scheme for the separation into the respective colors CMYK, and any of the systems can be set.

Furthermore, the encoded data may be separated into odd-numbered and even-numbered blocks, and stored respectively, for example, in the blocks B0, B1 of the HDD section 8.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

1. An image processing apparatus comprising:
a compression processing section which compresses and encodes image data;
a storage section which stores the encoded data;
a code separation section which separates and stores the data encoded by the compression processing section in separate regions of the storage section in accordance with a separation scheme set;
a key information preparation section which generates, as key information, information indicating a region in which each of the separated coded data is stored in the storage section and information indicating the separation scheme;
a code synthesis section which synthesizes the separated encoded data stored in the storage section, in accordance with the key information; and
an extension processing section which extends the encoded data synthesized by the code synthesis section.

2. The image processing apparatus according to claim 1, wherein the set separation scheme is to separate, the encoded data into direct-current and alternating-current components.

3. The image processing apparatus according to claim 1, wherein the set separation scheme is to separate, the encoded data into red, green, and blue components.

4. The image processing apparatus according to claim 1, wherein the set separation scheme is to separate, the encoded data is separated into cyan, magenta, yellow, and black components.

5. The image processing apparatus according to claim 1, wherein the set separation scheme is to separate, the encoded data into data blocks.

6. The image processing apparatus according to claim 1, which further comprising an interface section to be connected to an external device to communicate therewith, said external device having a storage section in which the encoded data separated by the code separation section is stored, and in which the coded data storage control section stores the separated encoded data in the storage section and in the storage section of the external device, and the key information preparation section generates the key information including information that indicates a storage region in which the separated coded data is stored in the external device.
